(19) United States
(12) Patent Application Publication
(10) Pub. No.: US 2005/0167318 A1
(43) Pub. Date: Aug. 4, 2005

(54) Cassette for substrate

(76) Inventors: Geun-Soo An, Cheonan-si (KR); Jae-Nam Cho, Cheonan-si (KR)

Correspondence Address: MCGUIREWOODS, LLP, 1750 TYSONS BLVD, SUITE 1800, MCLEAN, VA, 22102, US

(21) Appl. No.: 11/015,812

(22) Filed: Dec. 20, 2004

(30) Foreign Application Priority Data
Dec. 23, 2003 (KR) 10-2003-0095417

(51) Int. Cl. B65G 1/00

(52) U.S. Cl. 206/711

(57) ABSTRACT

A cassette for a substrate is provided, which includes: a frame; and a plurality sets of supporting members defining slots layered in a vertical direction, wherein each set of supporting members comprises: a plurality of first support bars that extend in a first horizontal direction, nave ends fixed to the frame, and mount the substrate; and a support wire that is coupled with the first support bars and has ends fixed to the frame.

### CROSS REFERENCE TO RELATED APPLICATION

This application claims priority to and the benefit of Korean Patent Application No. 10-2003-0095417, filed on Dec. 23, 2003, which is hereby incorporated by reference.

### BACKGROUND OF THE INVENTION

(a) Field of the Invention

The present invention relates to a cassette for substrate.

(b) Description of Related Art

Generally, a semiconductor substrate used for a semiconductor device or a glass substrate for a flat panel display such as a liquid crystal display (LCD) and an organic light emitting display (OLED) is transferred by a transport system during the fabrication of the semiconductor device or the display panel.

An LCD generally includes two panels made of glass substrates and a liquid crystal layer, while an OLED includes a signal panel made of glass substrates. The LCD displays images by applying voltages to field-generating electrodes disposed on the panels to generate electric fields, which determine the orientations of liquid crystal molecules in the liquid crystal layer. The OLED displays images by applying currents or voltages to light emitting diodes that emits light depending on the currents or voltages.

A conventional substrate transport apparatus for LCDs transfers glass substrates to several process equipments using cassettes, stockers, and indexers. Several substrates are received in cassettes, and the cassettes containing the substrates are stocked in a stocker. The substrates are taken out of the cassette by a robot indexer and brought into process equipments.

However, the conventional substrate transport apparatus may have several problems as the as the glass substrates becomes large, for example, larger than about 1,500 mm.

First, the large substrates stored in the cassette are apt to get drooping due to its heavy weight. In addition, heavier substrates require larger and heavy supporting bars in the cassette and the large and heavy supporting bars are apt to get drooping and to be trembled. Moreover, heavier substrates also require larger robot arms of indexers large and thus the pitch of horizontal shelves of a cassette gets large to increase the cassette and the stocker. The large and heavy substrates may also cause problems in other devices such as a cassette crane, a cassette conveyor, and a lifer for handing the cassettes.

### SUMMARY OF THE INVENTION

A cassette for a substrate is provided, which includes: a frame; and a plurality sets of supporting members defining slots layered in a vertical direction, wherein each set of supporting members comprises: a plurality of first support bars that extend in a first horizontal direction, have ends fixed to the frame, and mount the substrate; and a support wire that is coupled with the first support bars and has ends fixed to the frame.

The first support bars may be spaced apart from each other.

The support wire may be coupled with bottoms of the first support bars.

Each set of supporting members may further include a plurality of second support bars extending in a second horizontal direction intersecting the first horizontal direction, having ends fixed to the frame, and mounting the substrate.

The first support bars may include buffers disposed at top, which may include polyetheretherketone (PEEK).

The second support bars may have top surfaces having the same height as the buffer.

The frame may include Al and stainless steel and the first supporting bars may include carbon fiber reinforced plastics.

A cassette for a substrate is provided, which includes: a frame; and a plurality sets of supporting members defining slots layered in a vertical direction, wherein each set of supporting members comprises: a base having a horizontal plane; and a plurality of support columns that is disposed on the base and mount the substrate.

The base may include a plurality of base bars having ends fixed at the frame or a base plate having edges fixed at the frame.

The support columns may include polyetheretherketone (PEEK).

### BRIEF DESCRIPTION OF THE DRAWINGS

The present invention will become more apparent by describing embodiments thereof in detail with reference to the accompanying drawings in which:

FIG. 1 is a plan view of a cassette according to an embodiment of the present invention;

FIG. 2 is a sectional view of the cassette shown in FIG. 2;

FIG. 3 is an expanded sectional view of a portion A of the cassette shown in FIG. 2;

FIG. 4 is a plan view of a cassette according to an embodiment of the present invention;

FIG. 5 is a sectional view of the cassette shown in FIG. 4;

FIG. 6 is an expanded sectional view of a portion B of the cassette shown in FIG. 5; and

FIG. 7 is a plan view of a cassette according to an embodiment of the present invention.

### DETAILED DESCRIPTION OF EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein. In the drawings, like numerals refer to like elements throughout.

Then, cassettes for substrates will be described in detail with reference to accompanying drawings.

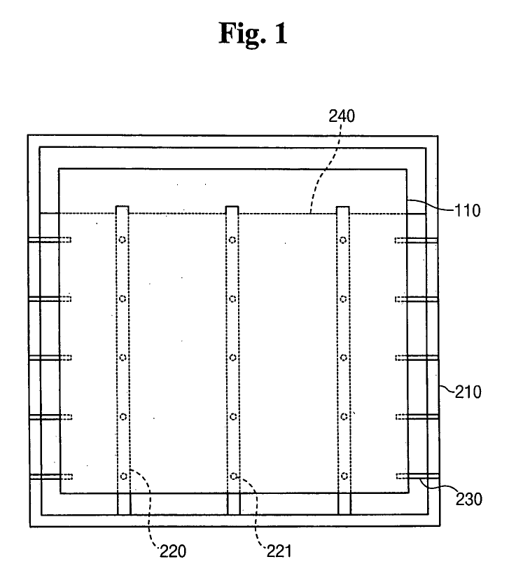

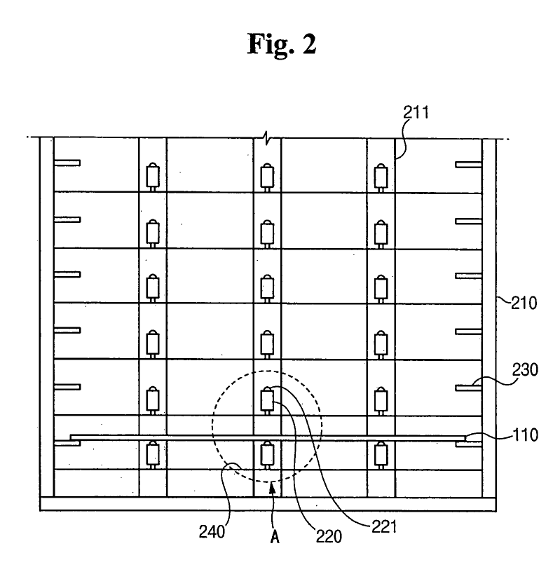

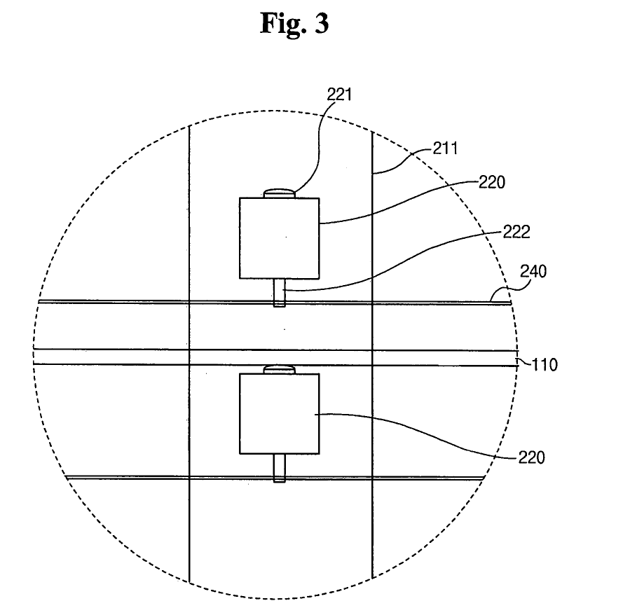

FIG. 1 is a plan view of a cassette according to an embodiment of the present invention, FIG. 2 is a sectional view of the cassette shown in FIG. 2, and FIG. 3 is an expanded sectional view of a portion A of the cassette shown in FIG. 2.

Referring to FIGS. 1-3, a cassette according to an embodiment of the present invention includes a cuboidal frame 210 and a plurality of slots layered in a vertical direction, each slot defined by a set of supporting members 220, 230 and 240 that mount a substrate 110.

The frame 210 includes three vertical walls and an entrance/exit for the substrate 110, and a rear wall facing the entrance/exit includes a plurality of vertical bars 211. The frame 210 is preferably made of Al and stainless steel such as SUS (Steel Use Stainless).

A set of supporting members include a plurality of, for example, three long, main support bars 220 horizontally extending from the vertical wall bars 211 of the frame 210, a support wire 240 connecting the main support bars 220, and a plurality of short, auxiliary support bars 230 extending horizontally extending from the frame 210.

A substrate 110 is mounted on the main support bars 220 and the auxiliary support bars 230 by robot transporting arms (not shown). The robot arms carrying the substrate 110 enter the space between the main support members 230, put down the substrate 110 on the main support members 230, and return.

The main support bars 220 are separated from each other and it is preferable that they extend parallel to one another. Each of the main supports 220 has a coupling member 222 at its bottom.

The main support bars 220 are preferably made of CFRP (carbon fiber reinforced plastics). CFRP is a polymer complex used for exterior structure, which has tensile modulus higher than about 4.5 times that of Al and specific modulus about 3.3 time that of Al. In addition, fatigue limit of CFRP is maintained up to about 80% of it initial value, while that of Al is equal to only about 35% of its initial value.

Each of the main support bars 220 includes a plurality of buffers 221 at its top and the buffers 221 absorb the impact during the mounting of the substrate 110. The buffer 221 is preferably made of PEEK (polyetheretherketone) that is a specific durable thermoplastic resin having a continuous use temperature (CUT) equal to about 250° C.

The support wire 240 is coupled with the main support bars 220 through the coupling members 222 and has ends fixed at the frame 210. The tension of the support wire 240 is adjusted by drawing or releasing the ends of the support wire 240. The support wire 240 prevents the main support bars 220 from being curved or trembling, when the main supports 220 mount the substrate 110. It is preferable that the support wire 240 is made of steel and has a diameter equal to about 3-5 mm.

It is preferable that the pitch of the support wires 240 (or the distance between adjacent support wires 240) is equal to about 75-95 mm and a gap between a support wire 240 and a buffer 221 adjacent thereto is about 50-70 mm such that an available space given to the transporting arms is about 80 mm.

The auxiliary support bars 230 horizontally extend from side walls of the frame 210 and support side edge portions of the substrate 110. The auxiliary support bars 230 preferably have top surfaces having the same height as the buffer 221 to maintain a mounted substrate 110 horizontal.

The extension directions of the auxiliary support bars 230 may make a right angle or an oblique angle with those of the main support bars 220.

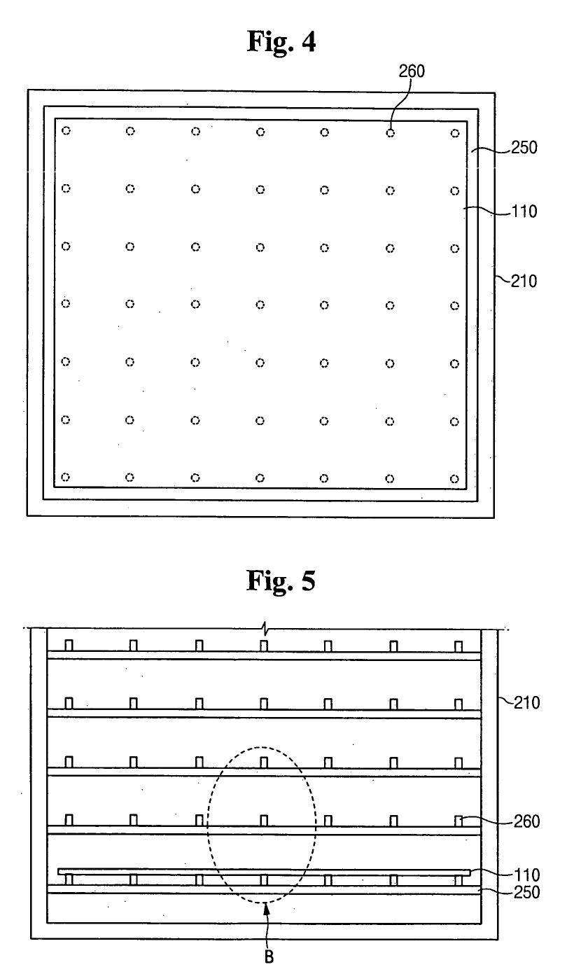

Next, a cassette according to another embodiment of the present invention will be described with reference to FIGS. 4-6.

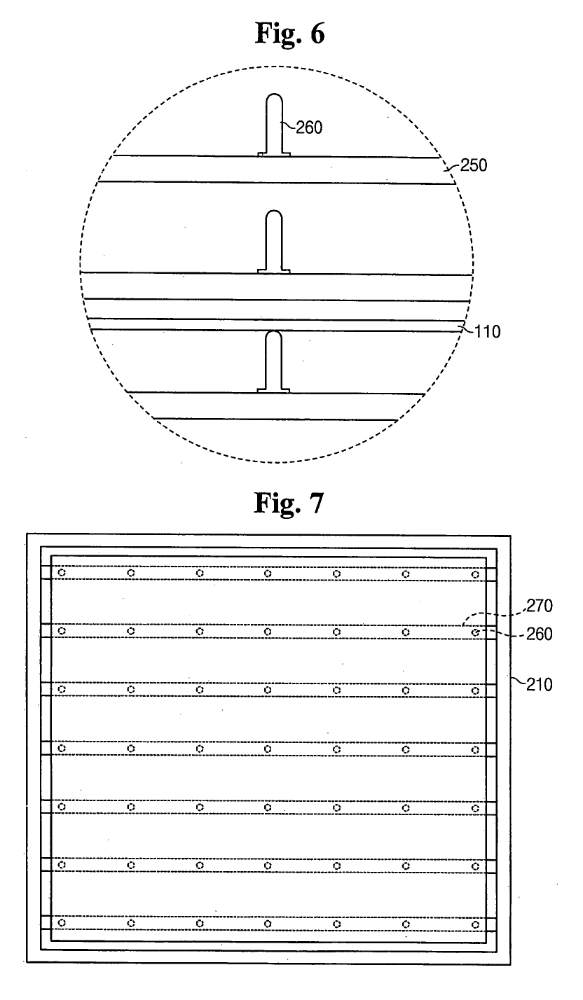

FIG. 4 is a plan view of a cassette according to an embodiment of the present invention, FIG. 5 is a sectional view of the cassette shown in FIG. 4, and FIG. 6 is an expanded sectional view of a portion B of the cassette shown in FIG. 5.

Referring to FIGS. 4-6, a cassette according to this embodiment includes a cuboidal frame 210 and a plurality of slots layered in a vertical direction, each slot defined by a set of supporting members 250 and 260 that mount a substrate 110.

The frame 210 includes three vertical walls and an entrance/exit for the substrate 110. The frame 210 is preferably made of Al and stainless steel such as SUS.

A set of supporting members include a base plate 250 having edges fixed at the walls of the frame 210 and a plurality of support columns 260 standing on the base plate 250. The support columns 260 are regularly arranged and preferably made of PEEK. The substrate 110 is mounted on the support columns 260.

Next, a cassette according to another embodiment of the present invention will be described with reference to FIG. 7.

FIG. 7 is a plan view of a cassette according to an embodiment of the present invention.

Referring to FIG. 7, a cassette according to this embodiment has a similar structure to that shown in FIGS. 4-6. That is, the cassette includes a cuboidal frame 210 and a plurality of slots layered in a vertical direction, each slot defined by a set of supporting members 260 and 270 that mount a substrate 110.

However, a set of supporting members include a plurality of horizontally extending base bars 270 having two opposite ends fixed at side walls of the frame 210 instead of a platelike base and a plurality of support columns 260 standing on the base bars 270. The cassette shown in FIG. 7 is lighter than that shown in FIGS. 4-6.

The cassettes shown in FIGS. 4-7 can easily store the substrate 110 in a flat state, and thus effectively prevents the substrate 110 from drooping and trembling.

To summarize, the cassettes according to the embodiments of the present invention prevent the substrate from being drooping and trembling. In addition, the support wire reduces the increase of the pitch between the slots and the increase of the weight of the cassette, thereby enabling to simplify and optimize the structure of the cassette.

While the present invention has been described in detail with reference to the preferred embodiments, those skilled in the art will appreciate that various modifications and substitutions can be made thereto without departing from the spirit and scope of the present invention as set forth in the appended claims.

1. A cassette for a substrate comprising:
a frame; and
a plural ity of sets of supporting members defining slots layered in a vertical direction,
wherein each set of supporting members comprises:
a plurality of first support bars that extend in a first horizontal direction; have ends fixed to the frame, and mount the substrate; and
a support wire that is coupled with the first support bars and has ends fixed to the frame.

2. The cassette of claim 1, wherein the first support bars are spaced apart from each other.

3. The cassette of claim 1, wherein the support wire is coupled with bottoms of the first support bars.

4. The cassette of claim 1, wherein the first support bars comprise buffers disposed at top.

5. The cassette of claim 4, wherein the buffers comprise polyetheretherketone (PEEK).

6. The cassette of claim 1, wherein each set of supporting members further comprise a plurality of second support bars extending in a second horizontal direction intersecting the first horizontal direction, having ends fixed to the frame, and mounting the substrate.

7. The cassette of claim 6, wherein the first support bars comprise buffers disposed at top.

8. The cassette of claim 7, wherein the second support bars have top surfaces having the same height as the buffer.

9. The cassette of claim 1, wherein the frame comprises Al and stainless steel.

10. The cassette of claim 1, wherein the first supporting bars comprise carbon fiber reinforced plastics.

11. A cassette for a substrate comprising:
a frame; and
a plurality of sets of supporting members defining slots layered in a vertical direction,
wherein each set of supporting members comprises:
a base having a horizontal plane; and
a plurality of support columns that is disposed on the base and mount the substrate.

12. The cassette of claim 11, wherein the base comprises a plurality of base bars having ends fixed at the frame.

13. The cassette of claim 11, wherein the base comprises a base plate having edges fixed at the frame.

14. The cassette of claim 11, wherein the support columns comprise polyetheretherketone (PEEK).
